(19) United States
(12) Patent Application Publication
(10) Pub. No.: US 2009/0240394 A1
(43) Pub. Date: Sep. 24, 2009

(54) Device for Monitoring and Recording Driver's Operations and the Peripheral Scene of a Motor Vehicle

(75) Inventors: Dake He, Sichuan (CN); Wei He, Sichuan (CN); Yu Zheng, Sichuan (CN)

Correspondence Address: COOK ALEX LTD, SUITE 2850, 200 WEST ADAMS STREET, CHICAGO, IL, 60606, US

(73) Assignee: SOUTHWEST JIAOTONG UNIVERSITY, Sichuan (CN)

(21) Appl. No.: 11/793,326

(22) PCT Filed: Dec. 20, 2005
(86) PCT No.: PCT/CN05/02252

§ 371 Date: Sep. 14, 2007

(30) Foreign Application Priority Data
Dec. 20, 2004 (CN) 200420105630.7

(51) Int. Cl. G06F 19/00

(52) U.S. Cl. 701/35

(57) ABSTRACT

A recording device for monitoring and recording the driver's operations and the peripheral scene of a motor vehicle, comprising information acquisition units and a central processing unit. The information acquisition units capture information such as image data, while the central processing unit stores and process the information captured by the information acquisition units. The device can record the driver's operations and the peripheral scene of the motor vehicle when an accident happens. The recorded information can be used for analyzing the accident.

### BACKGROUND OF THE INVENTION

1. Field of the Invention

The utility mode relates to a device for monitoring and recording the driver's operations and the peripheral scene of a motor vehicle.

2. Background of the Art

The Road Traffic Safety Law of the People's Republic of China took effect on May 1, 2004 stipulates that when accidents occur between pedestrians or non-motorised vehicles and motor vehicles, the motor vehicle's side must always bear responsibility. For the case where the pedestrian purposely initiate the accident and the vehicle drivers are not at fault, the new Road Traffic Safety Law supplements that responsibility for the motorised side is reduced if there are evidences to prove that the pedestrian or non-motorised side violated traffic laws and the driver of the motor vehicle has taken necessary measures. So, such evidences that can prove that the pedestrian or non-motorised side violated traffic laws and the driver of the motor vehicle has taken necessary measures are becoming the very valuable evidences to safeguard the vehicle driver's own legitimate rights. The existing “black box” for vehicles, i.e. a recorder for recording the driving status of a vehicle, can only provide the parameters on vehicles' driving status, such as speed, steering direction, mileage and traveling time, et al., but fails to directly record the driver's operations of the vehicle, as well as the peripheral scene or situations of the motor vehicle and other vehicles, non-motorised vehicles and drivers thereof or pedestrian which are approached or collided (crashed or injured) by the vehicle when the accident happens. The existing vehicle electronic monitors and image synthesis devices for the front, back, left and right views are only suitable to offer the real-time peripheral image information to the driver, but cannot save or provide the interpolation-resistant data records. Therefore, said known means cannot provide effectual evidences to protect vehicle drivers' legal rights. Till now, there are no such kind of devices to record driver's operations and the peripheral scene of the vehicle for the purpose of providing legal protections for vehicle drivers in resolution of traffic accidents.

### SUMMARY OF THE INVENTION

The object of the utility mode is to provide a device for monitoring and recording the driver's operations and the peripheral scene of a vehicle, which can record the driver's operations and the peripheral scene of the vehicle in a real-time and interpolation-resistant manner. Upon a traffic accident, the recorded data will serve as effectual evidences for the driver's operations and the peripheral scene on the spot, to ensure the legal rights of the driver and each party involved. Also, the spot of the accident and the image data at the spot can be submitted to the emergency succor and traffic administration department, to provide sound evidences for the department to handle traffic accidents or conflicts.

The utility mode solves the technical problem by means of a device for monitoring and recording the driver's operations and the peripheral scene of a motor vehicle, comprising information acquisition units and a central processing unit, wherein
a. Each one of said information acquisition units including: a data preprocessing module, an acquisition unit data storage module, an image acquisition module, a signal control module and an acquisition communication unit, wherein the data preprocessing module being connected to the acquisition unit data storage module, the image acquisition module and signal control module via a data address bus, respectively, the signal control module being connected with the control signal line of the image acquisition module, and signal control module being connected to the acquisition communication module as well;
b. Said central processing unit including: a central data processing module, a central unit data storage module, a non-volatile memory module, a clock calendar module, a high-speed general-purpose asynchronous serial interface module, a central communication module and a digital signature module, wherein the central data processing module being connected to the central unit data storage module, the non-volatile memory module and the clock calendar module via a data address bus, respectively, and being connected to the central communication module via the high-speed general-purpose asynchronous serial interface module, and the central data processing module being further connected to the digital signature module.

The principle of the utility mode is: the image acquisition module installed in vehicle's cab and on its bodywork collects the image information of driver's operations during the driving including his arm-and-leg actions, the speedometer, and the image information of the peripheral scene at the front, back, left and right sides of the vehicle; and then stores the collected image information into the acquisition unit data storage module under the synchronous control of the signal control module. Subsequently, the data preprocessing module sorts and selects the image information by frame, and then compresses the same. The compressed data are transmitted in real time from the acquisition communication module to the central communication module together with the corresponding time stamp generated by the clock calendar module, stored into the central unit data storage module, and then processed by the central processing unit. The data preprocessing module is also synchronized with the central processing unit by the acquisition communication module.

When an accident happens, the central data preprocessing module of the central processing unit is triggered. Then, in cooperation with the clock calendar module and the digital signature module, the image information intermediately stored in the central unit data storage module is grouped in time sequence, to which time stamps and digital signature interpolation-resistant latching are added, and then is stored into the non-volatile memory module. Synchronously, the information on the spot of the accident and the spot image data are submitted to the emergency succor and traffic administration department immediately by the unit communication module.

Since an embedded security access module (ESAM) with embedded user's public key certificate and signed private key is included in the digital signature module, which public key certificate and signed private key can be produced and issued by a trusty public organization, it is impossible to be forged and manipulated by the vehicle's owner. Once an accident happens, the validity of digital signature and the integrity of the latched data can be verified by using the corresponding user's public key.

The advantageous effects of the utility mode are: by obtaining the information on the driver's operations and the vehicle's peripheral scene, adding time stamps, latching the data for anti-manipulation purpose, and saving the records, the recorded data can serve as effectual evidences for indicating the driving situation and the peripheral scene upon an accident, in order to safeguard the legal rights of the driver and each party justly and effectively, and to facilitate the emergency response and expediate the resolution of the accident by the traffic administration department. The utility mode thereby offers a powerful technology support for the execution of the new Road Traffic Safety Law, and ensures the efficient and safe operation of the road traffic system.

Said data preprocessing module is preferably further connected to a collision detection module.

Alternatively or additionally, said central data processing module is further connected to a manual triggering circuit.

Thus, there are two ways to generate an accident triggered signal in the central data processing module of the central processing unit: 1) if the collision detection module detects that the vehicle's acceleration or deformation at the corresponding positions of the vehicle's bodywork caused by collision has exceeded a threshold value, the acquisition communication module and the central communication module will send an accident triggered signal to the central processing unit, to trigger the central data processing module; 2) the driver sends an accident triggered signal directly to the central processing unit by using the manual triggering circuit (19).

The central data processing module mentioned above is preferably further connected to an audio acquisition module, an on-board radio location module and an on-board digital panel system.

In this way, the central data processing module is able to obtain the parameters on the vehicle's status such as speed, mileage, etc., information on the spot and location, and the audio information such as voice and sound of brake. All such information is added with time stamps and processed with digital signature interpolation-resistant latching. The data “evidences” obtained by using the utility mode are more comprehensive and sufficient, so that it can more efficiently safeguard the legal rights and interests of the driver and each party. The acquisition communication module of said information acquisition units and the central communication module of said central processing unit are preferably wireless communication modules.

Alternatively, the acquisition communication module of said information acquisition units and the central communication module of said central processing unit can be wired communication modules.

Said central communication module is preferably further connected to a display module. Thus the image information of vehicle's peripheral scene can be displayed in real time on the display module provided in the vehicle, to provide the driver with assistance during driving and to make the travel even safer.

### BRIEF DESCRIPTION OF THE DRAWINGS

The utility mode will be better understood with reference to the accompanying figures and the exemplary embodiments:

FIG. 1 shows a schematic circuit structure of one of the information acquisition units according to a first embodiment of the utility mode.

FIG. 2 shows a schematic circuit structure of the central processing unit according to the first embodiment of the utility mode.

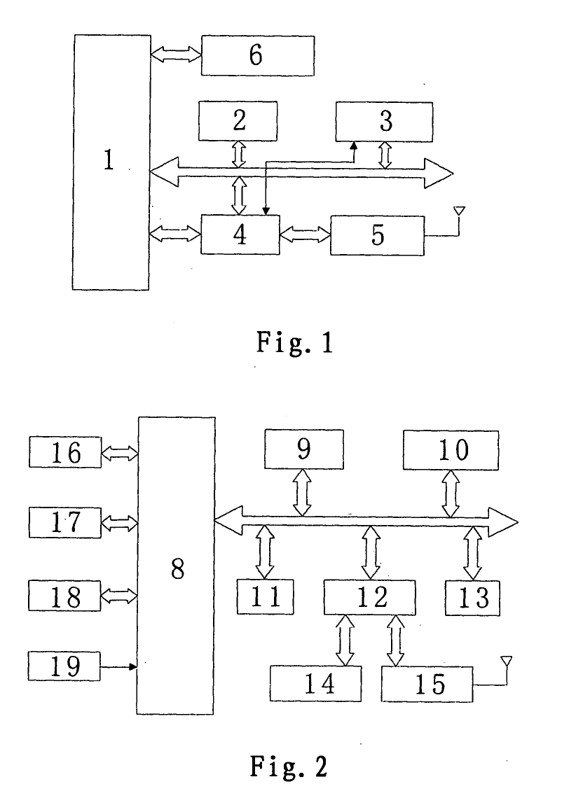

### DETAILED DESCRIPTION OF THE INVENTION

### Embodiment 1

An embodiment of the information acquisition units according to the utility mode is described as follows: a device for monitoring and recording the driver's operations and the peripheral scene of a motor vehicle, comprising information acquisition units and a central processing unit, wherein:
a) Each one of said information acquisition units including: a data preprocessing module 1, an acquisition unit data storage module 2, an image acquisition module 3, a signal control module 4 and an acquisition communication module 5, wherein the data preprocessing module 1 is connected to the acquisition unit data storage module 2, the image acquisition module 3 and the signal control module 4 via a data address bus, respectively, the signal control module 4 is connected with the signal control line of the image acquisition module 3, and the signal control module 4 is connected to the acquisition communication module 5 as well;
b) Said central processing unit including: a central data processing module 8, a central unit data storage module 11, a non-volatile memory module 10, a clock calendar module 13, a high-speed general-purpose asynchronous serial interface module 12, a central communication module 15 and a digital signature module 16, wherein the central data processing module 8 is connected to the central unit data storage module 11, the non-volatile memory module 10 and the clock calendar module 13 via a data address bus, respectively, and is connected to the central communication module 15 via the high-speed general-purpose asynchronous serial interface module 12, and the central data processing module 8 is further connected to the digital signature module 16.

In this example, the data preprocessing module 1 is implemented by a TMS3206205 processor. The signal control module 4 can employ various programmable logic devices, such as FPGA (Field Programmable Gate Array), et al.

The Image acquisition module 3 in this example can be implemented by a CCD (Charge-Coupled Device) digital camera or a CMOS digital camera, which are respectively arranged in vehicle's cab (two or more) and around its bodywork, which obtains the image information on the driver's operations including his arm-and-leg actions during driving, the speedometer, and the peripheral scene at the front, back, left and right sides of the vehicle. Alternatively, the image acquisition module 3 can also be implemented by a CCD camera with night vision function, so as to ensure the image acquisition module 3 to work at night as usual.

In this example, the data preprocessing module 1 of the information acquisition units is further connected to a collision detection module 6, and the central data processing module 8 is further connected to a manual triggering circuit 19.

The central data processing module 8 of the central processing unit in this example is further connected to an audio acquisition module 17, an on-board radio location module 14 and an on-board digital panel system 18. The central data processing module 8 is connected to the central communication module 15 and the on-board radio location module 14 via the high-speed general-purpose asynchronous serial interface module 12 coupled with the data address bus.

The central data processing module 8 reassembles the image data having the same time stamp in the central unit data storage module 11, and submits the same to the digital signature module 16 together with the audio data in the previous corresponding duration, as well as other vehicle status data and position information with the identical time stamp, to be signed and latched. According to the present embodiment, the non-volatile memory module 10 of the central processing unit is implemented by a flash memory card with a USB interface, and the flash memory card 10 can be connected to a computer through the USB interface. When an accident takes place, the driver of the vehicle can take the flash memory card 10 with a USB interface out of the central processing unit, and then upload the images and the audio data to the computer through the USB interface. After a trusty public organization has checked up the integrality and validity of the data by using the vehicle driver's public key, the accident's course can be rebuilt and reproduced on the computer in the form of images and audio data, so as to offer effectual evidences for protecting the legal rights of the driver and each party conveniently.

The acquisition communication module 5 and the central communication module 15 are implemented by wireless communication modules, such as Bluetooth radio communication modules. The data preprocessing module 1 realizes the high-speed serial communication with the Bluetooth radio acquisition communication module 5 by using the function of the signal simulation general-purpose asynchronous serial interface.

The central data processing module 8 is further connected to a display module 9. As to a vehicle equipped with a liquid crystal display, the display module 9 can be implemented by the liquid display directly.

As to a vehicle equipped with GPS (Global Position System), the on-board radio location module 14 according to the utility mode can be implemented directly by the GPS. The central data processing module 8 can be directly connected to the GPS via the general-purpose asynchronous serial interface module 12. The central data processing module 8 can obtain the time information and the current position of the vehicle from the GPS via the general-purpose asynchronous serial interface module 12, so that the clock calendar module 13 separately arranged in the central processing unit can be dispensed.

### Embodiment 2

The configuration, components and working principle of Embodiment 2 are similar to Embodiment 1, and the only difference lies in that: the acquisition communication module 5 of the information acquisition units and the central communication module 15 of the central processing unit are wired communication modules, i.e. typically wired communication module based on CAN (Controller Area Network) bus.

What is claimed is:

1. A device for monitoring and recording the driver's operations and the peripheral scene of a motor vehicle, comprising information acquisition units and a central processing unit, wherein
a) each one of said information acquisition units including: a data preprocessing module (1), an acquisition unit data storage module (2), an image acquisition module (3), a signal control module (4) and an acquisition communication module (5), wherein the data preprocessing module (1) being connected to the acquisition unit data storage module (2), the image acquisition module (3) and the signal control module (4) via a data address bus, respectively, the signal control module (4) being connected with the signal control line of the image acquisition module (3), and the signal control module (4) being connected to the acquisition communication module (5) as well;
b) said central processing unit including: a central data processing module (8), a central unit data storage module (11), a non-volatile memory module (10), a clock calendar module (13), a high-speed general-purpose asynchronous serial interface module (12), a central communication module (15) and a digital signature module (16), wherein the central data processing module (8) being connected to the central unit data storage module (11), the non-volatile memory module (10) and the clock calendar module (13) via a data address bus, respectively, and being connected to the central communication module (15) via the high-speed general-purpose asynchronous serial interface module (12), and the central data processing module (8) being further connected to the digital signature module (16).

2. A device for monitoring and recording the driver's operations and the peripheral scene of a motor vehicle according to claim 1, characterized in that the data preprocessing module (1) is further connected to a collision detection module (6).

3. A device for monitoring and recording the driver's operations and the peripheral scene of a motor vehicle according to claim 1, characterized in that the central data processing module (8) is further connected to a manual triggering circuit (19).

4. A device for monitoring and recording the driver's operations and the peripheral scene of a motor vehicle according to claim 1, characterized in that the central data processing module (8) is further connected to an audio acquisition module (17), an on-board radio location module (14) and an on-board digital panel system (18).

5. A device for monitoring and recording the driver's operations and the peripheral scene of a motor vehicle according to claim 1, characterized in that the acquisition communication module (5) of the information acquisition units and the central communication module (15) of the central processing unit are wireless communication modules.

6. A device for monitoring and recording the driver's operations and the peripheral scene of a motor vehicle according to claim 1, characterized in that the acquisition communication module (5) of the information acquisition units and the central communication module (15) of central processing unit are wired communication modules.

7. A device for monitoring and recording the driver's operations and the peripheral scene of a motor vehicle according to claim 1, characterized in that the central communication module (15) is further connected to a display module (9).
